(19) United States
(12) Patent Application Publication
(10) Pub. No.: US 2016/0231980 A1
(43) Pub. Date: Aug. 11, 2016

(54) Wireless Signal Transmission Device and Sound System Having the Same

(71) Applicant: Ping-Yang Chuang, New Taipei City (TW)

(72) Inventor: Ping-Yang Chuang, New Taipei City (TW)

(21) Appl. No.: 15/012,886

(22) Filed: Feb. 2, 2016

Related U.S. Application Data
(60) Provisional application No. 62/113,560, filed on Feb. 9, 2015.

(51) Int. Cl. G06F 3/16; H04R 3/00

(52) U.S. Cl. CPC G06F 3/162; H04R 3/00; H04R 2420/09; H04R 2420/07

(57) ABSTRACT

A wireless signal transmission device and a sound system having the same are disclosed. The wireless signal transmission device is used for connecting to an audio amplifier, wherein the audio amplifier includes at least one connecting hole. The wireless signal transmission device includes a chassis, a base board, an antenna, a control module, and at least one signal transmission port. The antenna is used for emitting or receiving an audio signal. The control module is used for controlling the transmission or reception of the audio signal. The at least one signal transmission port is used for connecting to the at least one connecting hole of the audio amplifier directly for transmitting the audio signal, wherein the chassis is able to be supported by the at least one connecting hole according to a connection between the at least one signal transmission port and the at least one connecting hole.

### BACKGROUND OF THE INVENTION

1. Field of the Invention

The present invention relates to a wireless signal transmission device and a sound system having the same, and particularly to a wireless signal transmission device that can be directly supported by an audio amplifier and a sound system having the wireless signal transmission device.

2. Description of the Related Art

With advances in technology, nowadays an audio amplifier can be connected with an audio cable to a radio receiver or transmitter with a wired connection, whereby an audio signal can be broadcasted. In the prior art, the radio receiver or transmitter is placed on a surface and then connected to the audio amplifier with a wired connection. However, this connection may result in greater attenuation and distortion if the audio cable is too long. In addition, placing the radio receiver or transmitter on another surface requires a matched storage space and suitable placement height. If the audio receiver or transmitter is arbitrarily placed, interference with the transmission effect of an antenna on the audio receiver or transmitter can result from an improper placement location. The placement may result in a poor electromagnetic field, which can affect the quality of reception. This may also cause inconvenience in using the audio receiver or transmitter and thus decrease the willingness of the user to use the audio device.

Accordingly, there is a need to provide a new wireless signal transmission device and a sound system having the same to address the deficiency in the prior art.

### SUMMARY OF THE INVENTION

It is a major objective of the present invention to provide a wireless signal transmission device having a structure that can be directly supported by an audio amplifier.

It is another major objective of the present invention to provide a sound system having the wireless signal transmission device described above.

To achieve the objectives described above, the wireless signal transmission device of the present invention is used for connecting to an audio amplifier, wherein the audio amplifier includes at least one connecting hole. The wireless signal transmission device includes a chassis, a base board, an antenna, a control module, and at least one signal transmission port. The base board is disposed in the chassis. The antenna disposed on the base board is used for emitting or receiving an audio signal. The control module, which is disposed on the base board and electrically connected to the antenna, is used for controlling the transmission or reception of the audio signal. The at least one signal transmission port, which is electrically connected to the control module and directly connected to the at least one connecting hole of the audio amplifier, is used for transmitting the audio signal. Specifically, the chassis is able to be supported by the at least one connecting hole according to a connection between the at least one signal transmission port and the at least one connecting hole.

The sound system having a wireless signal transmission device of the present invention includes an audio amplifier and a wireless signal transmission device. The audio amplifier includes at least one connecting hole. The wireless signal transmission device is used for electrically connecting to the audio amplifier. The wireless signal transmission device includes a chassis, a base board, an antenna, a control module, and at least one signal transmission port. The base board is disposed in the chassis. The antenna disposed on the base board is used for transmitting or receiving an audio signal. The control module, which is disposed on the base board and electrically connected to the antenna, is used for controlling the emitting or receiving of the audio signal. The at least one signal transmission port, which is electrically connected to the control module and directly connected to the at least one connecting hole of the audio amplifier, is used for transmitting the audio signal. Specifically, the chassis is able to be supported by the at least one connecting hole according to a connection between the at least one signal transmission port and the at least one connecting hole.

### BRIEF DESCRIPTION OF THE DRAWINGS

FIG. 1 is an assembly diagram of a wireless signal transmission device and an audio amplifier according to a first embodiment of the present invention;

FIG. 2 is an assembly diagram of a wireless signal transmission device and an audio amplifier according to a second embodiment of the present invention;

FIG. 3 is an assembly diagram of a wireless signal transmission device and an audio amplifier according to a third embodiment of the present invention; and

FIG. 4 is an assembly diagram of a wireless signal transmission device and an audio amplifier according to a fourth embodiment of the present invention.

### DETAILED DESCRIPTION OF THE PREFERRED EMBODIMENT

Hereafter, the technical content of the present invention will be better understood with reference to preferred embodiments.

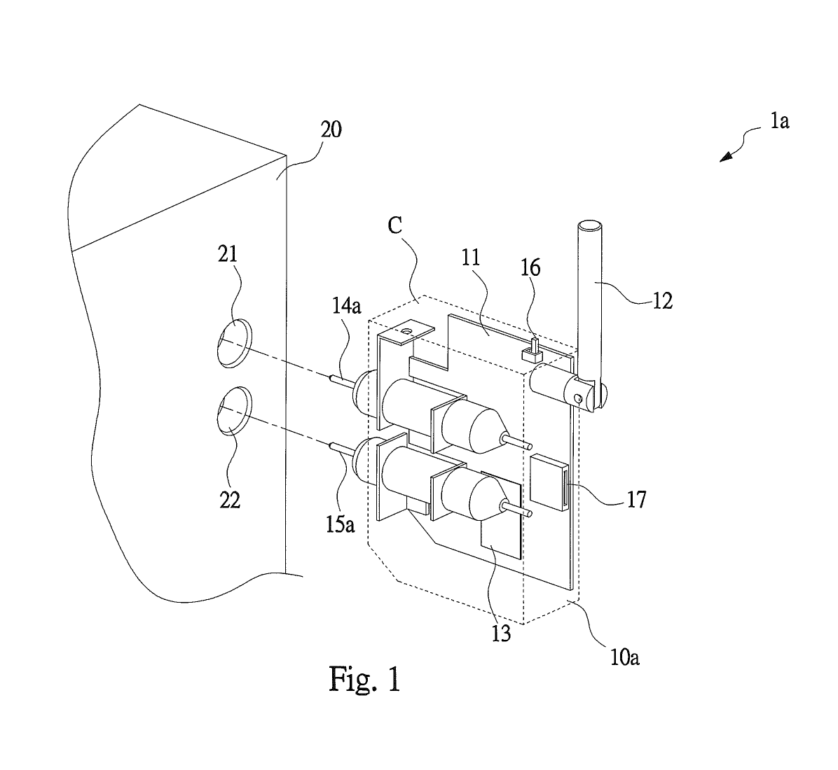

Hereinafter, please first refer to FIG. 1, which is an assembly diagram of a wireless signal transmission device and an audio amplifier according to a first embodiment of the present invention.

A sound system 1a of the present invention includes a wireless signal transmission device 10a and an audio amplifier 20 connected thereto. The audio amplifier 20 can be used for amplifying an audio signal. A panel on the audio amplifier 20 may be provided with a plurality of connecting holes. The audio amplifier 20 in FIG. 1 includes a signal receiving connecting hole 21 and a signal transmission connecting hole 22. Both the signal receiving connecting hole 21 and the signal transmission connecting hole 22 may be female RCA connectors, but the present invention is not limited to that specification. Since the audio amplifier 20 is widely used in today's environment, the functionality will not be described in detail herein. The wireless signal transmission device 10a includes a chassis C, a base board 11, an antenna 12, a control module 13, a first signal transmission port 14a, and a second signal transmission port 15a. The base board 11 is disposed in the chassis C and may be a printed circuit board (PCB), but the present invention is not limited thereto. The antenna 12 is disposed on the base board 11 and is used for transmitting or receiving an audio signal, such as a radio signal. The control module 13 may be a chip in the architecture of hardware, hardware with firmware, or hardware with software. The control module 13 is also disposed on the base board 11 and electrically connected to the antenna 12 for controlling the receiving, transmission or conversion of audio signals, such as the conversion of a digital signal received by the antenna 12 to an analog signal able to be received by the audio amplifier 20. However, the present invention is not limited to only the control module 13 performing this procedure.

The first signal transmission port 14a and the second signal transmission port 15a are connected to the control module 13 for transmitting the audio signal. Specifically, the first signal transmission port 14a is directly connected to a signal receiving connecting hole 21 of the audio amplifier 20 to transmit the audio signal to the audio amplifier 20. The second signal transmission port 15a is directly connected to a signal transmission connecting hole 22 of the audio amplifier 20 to receive the audio signal from the audio amplifier 20. Also, the at least one connecting hole (e.g., the signal receiving connecting hole 21 or the signal transmission connecting hole 22 in FIG. 1) connected to the audio amplifier 20 is supported by the chassis C of the wireless signal transmission device 10a through the at least one signal transmission port (e.g., the first signal transmission port 14a or the second signal transmission port 15a in FIG. 1).

In a first embodiment of the present invention, both the first signal transmission port 14a and the second signal transmission port 15a are male RCA connectors for plugging into a signal receiving connecting hole 21 and a signal transmission connecting hole 22, both of which are female RCA connectors. As such, the signal receiving connecting hole 21 and the signal transmission connecting hole 22 of the audio amplifier 20 can be supported by the chassis C. Also, since the connector specifications of the RCA connector can provide adequate support, the chassis C can be firmly supported by the signal receiving connecting hole 21 or the signal transmission connecting hole 22 of the audio amplifier 20. In addition, the direct connection between the audio amplifier 20 and the antenna 12 through the first signal transmission port 14a and the second signal transmission port 15a allows users to employ the wireless signal transmission device 10a in an intuitive way without requiring special consideration of the placement of the wireless signal transmission device 10a. Furthermore, the problem that the transmission path is too long will not occur, so the problems of the signal fading or distortion are prevented.

In addition, the wireless signal transmission device 10a may also include a switch 16 and a memory card slot 17. The switch 16 is disposed on the base board 11 for users to control the operations of the wireless signal transmission device 10a. The memory card slot 17 is used for inserting a device such as a memory card (not shown) to achieve expansion capabilities of the wireless signal transmission device 10a. Since the functionality of the switch 16 and the memory card slot 17 is not the aspect of the present invention to be improved, the principle will not be described in detail herein.

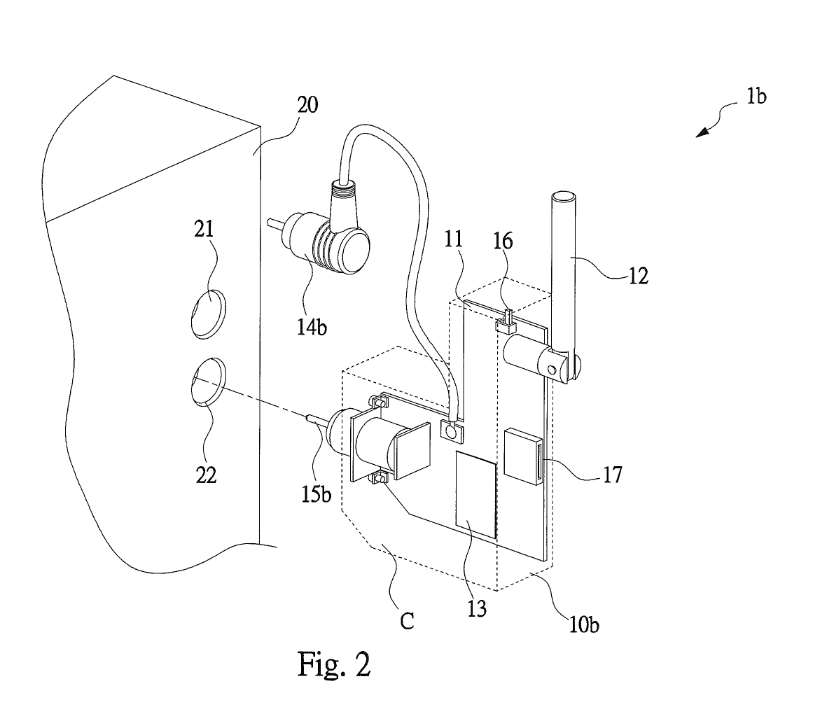

Now please refer to FIG. 2, which is an assembly diagram of a wireless signal transmission device and an audio amplifier according to a second embodiment of the present invention.

In the second embodiment of the present invention, similarly, a wireless signal transmission device 10b of a sound system lb includes a chassis C, a base board 11, an antenna 12, a control module 13, a first signal transmission port 14b, a second signal transmission port 15b, a switch 16 and a memory card slot 17. The functionalities of the base board 11, the antenna 12, the control module 13, the switch 16, and the memory card slot 17 are the same as those in the first embodiment and thus will not be repeated herein. In addition, the first signal transmission port 14b in the second embodiment may be a male connector having a flexible cable, and its joint angle may be rotated 90 degrees to allow for the connection to the signal receiving connecting hole 21. The second signal transmission port 15b is a hard male connector and directly connected to the signal transmission connecting hole 22 such that the chassis C can be supported by the signal transmission connecting hole 22 of the audio amplifier 20 by means of the second signal transmission port 15b without falling off.

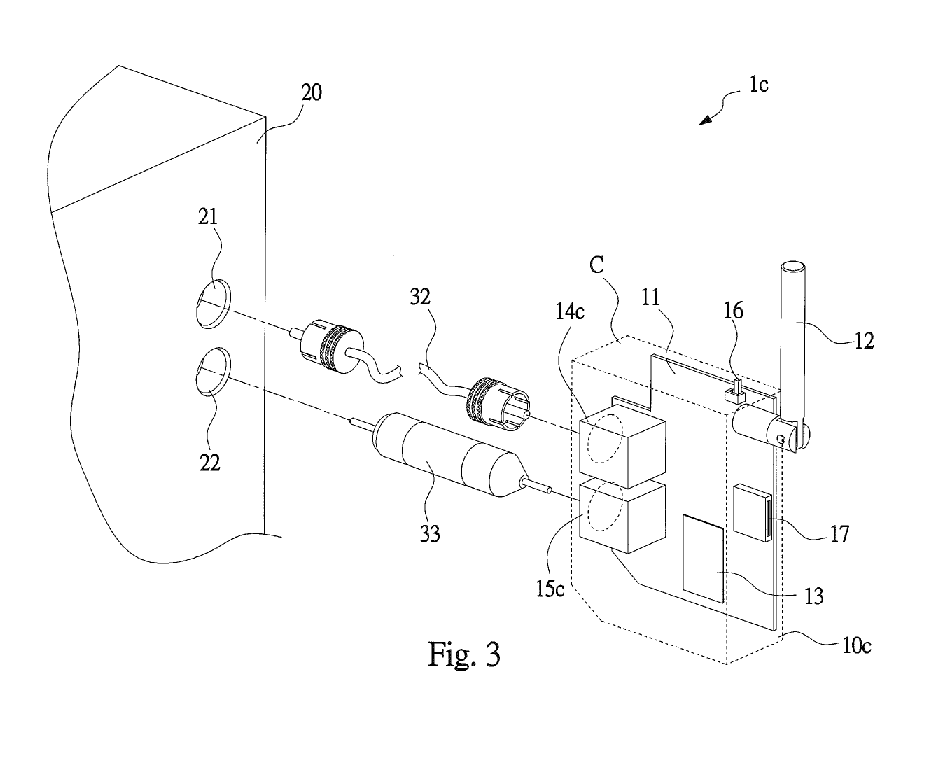

Now please refer to FIG. 3, which is an assembly diagram of a wireless signal transmission device and an audio amplifier according to a third embodiment of the present invention.

In the third embodiment of the present invention, the forms of the first signal transmission port 14c and the second signal transmission port 15c included in a wireless signal transmission device 10c of a sound system 1c are different from those in the first or second embodiment described above. Both the first signal transmission port 14c and the second signal transmission port 15c are female RCA connectors. The first signal transmission port 14c is connected to the signal receiving connecting hole 21 through a flexible cable 32, while the second signal transmission port 15c is directly connected to the signal transmission connecting hole 22 through a rigid double male connector 31. Accordingly, the chassis C can be supported by the second signal transmission port 15c. It should be noted that the first signal transmission port 14c and the second signal transmission port 15c can be connected to the audio amplifier 2 simultaneously by means of the rigid double male connector 31, but the present invention is not limited thereto.

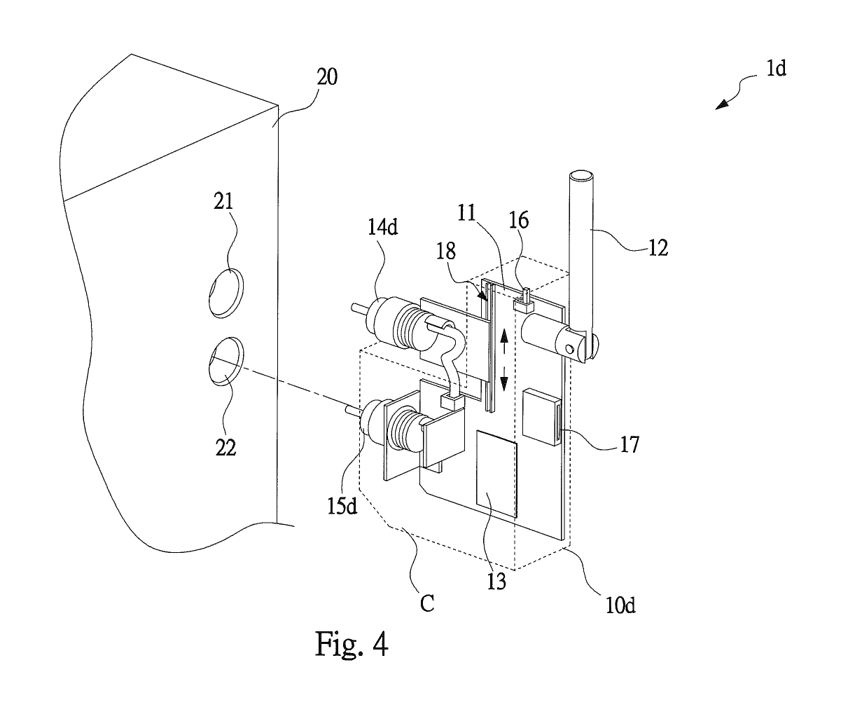

Last, please refer to FIG. 4, which is an assembly diagram of a wireless signal transmission device and an audio amplifier according to a fourth embodiment of the present invention.

In the fourth embodiment of the present invention, the forms of the first signal transmission port 14d and the second signal transmission port 15d included in the wireless signal transmission device 10d of the sound system 1d are not different from those in the embodiments described above. The first signal transmission port 14d and the second signal transmission port 15d are both male RCA connectors. However, the wireless signal transmission device 10d further includes a slide rail 18 on which the first signal transmission port 14d is disposed such that the first signal transmission port 14d can slide along the slide rail. Accordingly, when the wireless signal transmission device 10d is connected to the audio amplifier 20, the slide rail 18 can be used in conjunction with the spacing distance between the signal receiving connecting hole 21 and the signal transmission connecting hole 22 to adjust the position of the first signal transmission port 14d.

Any of the wireless signal transmission devices 10a, 10b, 10c, 10d of the present invention can be directly connected to the signal receiving connecting hole 21 or the signal transmission connecting hole 22 of the audio amplifier 20, which allows users to employ the devices 10a, 10b, 10c, 10d of the present invention in a more intuitive way. Also, through the support of the signal receiving connecting hole 21 or the signal transmission connecting hole 22 of the audio amplifier 20, the problem of antenna interference can be avoided, and wiring can be achieved as well.

As described above, the objective, means, and efficiency of the present invention are all different from conventional characteristics in the prior art. It will be appreciated if the committee can review and grant a patent to benefit society. However, it should be noted that the described embodiments are only for illustrative and exemplary purposes, and that various changes and modifications may be made to the described embodiments without departing from the scope of the invention as specified by the appended claims.

What is claimed is:

1. A wireless signal transmission device used for connecting to an audio amplifier, wherein the audio amplifier includes at least one connecting hole, the wireless signal transmission device comprising:
a chassis;
a base board, which is disposed in the chassis;
an antenna, which is disposed on the base board and used for transmitting or receiving an audio signal;
a control module, which is disposed on the base board and electrically connected to the antenna, used for controlling the transmission and reception of the audio signal; and
at least one signal transmission port, which is electrically connected to the control module and directly connected to the at least one connecting hole of the audio amplifier for transmitting the audio signal, wherein the wireless signal transmission device is connected to the at least one connecting hole of the audio amplifier through the at least one signal transmission port such that the chassis of the wireless signal transmission device is able to be supported by the at least one connecting hole.

2. The wireless signal transmission device as claimed in claim 1, wherein the audio amplifier comprises a signal receiving connecting hole and a signal transmission connecting hole, the wireless signal transmission device further comprising:
a first signal transmission port, which is electrically connected to the control module and directly connected to the signal receiving connecting hole of the audio amplifier for transmitting the audio signal to the audio amplifier; and
a second signal transmission port, which is electrically connected to the control module and directly connected to the signal transmission connecting hole of the audio amplifier for receiving the audio signal from the audio amplifier, wherein the wireless signal transmission device is supported by and connected to at least one of the signal receiving connecting hole and the signal transmission connecting hole through at least one of the first signal transmission port and the second signal transmission port of the audio amplifier.

3. The wireless signal transmission device as claimed in claim 2, further including a memory card slot disposed on the base board.

4. The wireless signal transmission device as claimed in claim 2, further including a switch disposed on the base board.

5. The wireless signal transmission device as claimed in claim 2, further including a slide rail on which the first signal transmission port is disposed such that the first signal transmission port is able to slide along the slide track.

6. The wireless signal transmission device as claimed in claim 2, wherein at least one male connector is included in the first signal transmission port and the second signal transmission port.

7. The wireless signal transmission device as claimed in claim 6, wherein one of the first signal transmission port and the second signal transmission port is a male connector of a flexible cable.

8. The wireless signal transmission device as claimed in claim 2, wherein both the first signal transmission port and the second signal transmission port are female connectors.

9. The wireless signal transmission device as claimed in claim 8, wherein one of the first signal transmission port and the second signal transmission port is connected to the signal receiving connecting hole or the signal transmission connecting hole of the audio amplifier through a rigid double male connector.

10. The wireless signal transmission device as claimed in claim 1, wherein the first signal transmission port, the second signal transmission port, the signal receiving connecting hole, and the signal transmission connecting hole are all RCA connectors.

11. A sound system having a wireless signal transmission device, comprising:
an audio amplifier, having at least one connecting hole; and
a wireless signal transmission device, which is used for electrically connecting to the audio amplifier, the wireless signal transmission device comprising:
a chassis;
a base board, which is disposed in the chassis;
an antenna, which is disposed on the base board and used for transmitting or receiving an audio signal;
a control module, which is disposed on the base board and electrically connected to the antenna, used for controlling the transmission or reception of the audio signal; and
at least one signal transmission port, which is electrically connected to the control module and directly connected to the at least one connecting hole of the audio amplifier, used for transmitting the audio signal, wherein the chassis of the wireless signal transmission device is able to be supported by the at least one connecting hole through the connection between the at least one signal transmission port and the at least one connecting hole of the audio amplifier.

12. The sound system having the wireless signal transmission device as claimed in claim 11, wherein the audio amplifier includes a signal receiving connecting hole and a signal transmission connecting hole, the wireless signal transmission device further comprising:
a first signal transmission port, which is electrically connected to the control module and directly connected to the signal receiving connecting hole of the audio amplifier for transmitting the audio signal to the audio amplifier; and
a second signal transmission port, which is electrically connected to the control module and directly connected to the signal transmission connecting hole of the audio amplifier for receiving the audio signal of the audio amplifier, wherein the wireless signal transmission device is supported by and connected to at least one of the signal receiving connecting hole and the signal transmission connecting hole through at least one of the first signal transmission port and the second signal transmission port.

13. The sound system having the wireless signal transmission device as claimed in claim 12, wherein the wireless signal transmission device further includes a memory card slot disposed on the base board.

14. The sound system having the wireless signal transmission device as claimed in claim 12, wherein the wireless signal transmission device further includes a switch disposed on the base board.

15. The sound system having the wireless signal transmission device as claimed in claim 12, wherein the wireless signal transmission device further includes a slide rail on which the first signal transmission port is disposed such that the first signal transmission port is able to slide.

16. The sound system having the wireless signal transmission device as claimed in claim 12, wherein the first signal transmission port and the second signal transmission port include at least one male connector.

17. The sound system having the wireless signal transmission device as claimed in claim 16, wherein one of the first signal transmission port and the second signal transmission port is a male connector having a flexible cable.

18. The sound system having the wireless signal transmission device as claimed in claim 12, wherein both the first signal transmission port and the second signal transmission port are female connectors.

19. The sound system having the wireless signal transmission device as claimed in claim 18, wherein one of the first signal transmission port and the second signal transmission port is connected to the signal receiving connecting hole or the signal transmission connecting hole of the audio amplifier through a rigid double male connector.

20. The sound system having the wireless signal transmission device as claimed in claim 12, wherein the first signal transmission port, the second signal transmission port, the signal receiving connecting hole, and the signal transmission connecting hole are all RCA connectors.
